(19) United States
(12) Patent Application Publication
(10) Pub. No.: US 2012/0095144 A1
(43) Pub. Date: Apr. 19, 2012

(54) ADDITIVE CONCENTRATE FOR POLYMERS

(76) Inventors: Jules Caspar Albert Anton Roelofs, Apeldoom (NL); Johan Gerrit, Apeldoom (NL)

(21) Appl. No.: 13/263,661

(22) PCT Filed: Apr. 7, 2010
(86) PCT No.: PCT/NL10/50181

§ 371 Date: Dec. 14, 2011

(30) Foreign Application Priority Data
Apr. 9, 2009 (EP) 09157528.2

(51) Int. Cl. C08K 5/103; C08L 23/12; C08L 67/02; C09K 15/00

(52) U.S. Cl. 524/311; 252/182.12; 252/188.28

(57) ABSTRACT

The invention is directed to a concentrate comprising a liquid carrier material and at least one additive for a polymer or polymer blend, wherein the liquid carrier material is a fatty acid ester of trimethylolpropane, wherein the fatty acid is a C6 to C16 fatty acid having a linear or branched chain, oleate or isostearate, and wherein the additive is more specifically a colourant, such as a dye or pigment.

The invention is directed to a concentrate of an additive for introducing the additive into a polymer or a polymer blend by melt blending.

If a colour has to be introduced in a plastic or polymer article, it is conventionally performed by mixing colourants like dyes or pigments with the polymeric resin, usually in granule or powder form charged to the hopper of an extruder or injection molding machine used to produce the desired plastic article. This article could be a bottle preform, pipe, box, bottle, fibre, film or sheet, but is not limited to that. The same applies to additives that have to be introduced in a plastic material.

For the purpose of adding additives, the additive, such as pigment or mixture of pigments, can be added as a solid concentrate or in powder form or as a dispersion in a liquid carrier. Such a liquid carrier is generally an inert material comprising materials like hydrocarbon oils, edible oils, esters, alcohols, or a mixture of two or more thereof.

Any such carrier must be selected so as to have good compatibility with the plastic. In addition, if the moulding composition is to be used for manufacture of food packages, the carrier must be non-toxic. In case of a not good compatibility, migration of the carrier out of the resin can cause problems like off taste via migration, haze (esp. in polyester applications), delamination or mechanical failure.

At any cost, addition of colour/additives concentrates should not slow down the production rate of the plastic article. Examples of this are slippage of the screw of the extruder and loss of injection pressure with polyesters. The carrier should also be non-reactive to the processing conditions: no thermal hydrolytic or oxidative degradation or reaction with the polymer chains should take place. Black spots due to this are common phenomena in every days practice resulting in an increase of off spec material. Also the addition itself of the liquid concentrate should be carefully monitored; the viscosity and stability of the concentrate should be stable to prevent a colour shift during production.

In general, the amount of carrier used should desirably be kept to a minimum so as not to affect adversely the properties of the plastic article. It is known to the person skilled in the art that depending on the polymer, usually a specific carrier has to be used. A carrier suitable for polyesters usually has different requirements than a carrier suitable for polyolefins or styrene polymers.

There is a need for concentrates that posses the above advantageous properties, more in particular that are generally applicable in a wide range of polymers, that are stable under the usual processing conditions and that do not adversely affect the polymer properties.

Surprisingly, we have found that certain trimethylolpropane esters can be used as carrier for colorants and additives for the use in various plastics and applications thereof. These carriers show a superior performance even at very high addition levels. Also the variety of different polymers which can be used is surprising. These polymer and polymer blends include polyesters such as PET, PEN, PBT, polycarbonate, polylactide, but also ethylene polymers, propylene polymers and styrene polymers.

Accordingly the invention is in a first embodiment directed to a concentrate comprising a liquid carrier material and at least one additive for a polymer or polymer blend, wherein the liquid carrier material is a fatty acid ester of trimethylolpropane, wherein the fatty acid is a C6 to C16 fatty acid having a linear or branched chain, oleate or isostearate.

In a further embodiment the invention is directed to the use of such a concentrate for introducing an additive or a colourant in a polymer or polymer blend by melt blending the concentrate with a melt of a polymer of polymer blend.

In a third embodiment the invention is directed to a process for producing a polyester material comprising adding a concentrate according to the invention to a melt of a polyester, melt blending the concentrate and the polyester and shaping the blend thus obtained to a.o. a preform, bottle, fibre, film or sheet.

As indicated above, the invention is based on the use of C6 to C16 fatty acids, oleate or isostearate esters of trimethylolpropane (2-ethyl-2-(hydroxymethyl)-1,3 propaandiol) as liquid carrier for additives and/or colourants (such as dyes and pigments) for polymers. Although preference is for the use as colour concentrate, it is also possible to use the carrier for polymer additives, such as a strengthening agent, a UV absorber, AA scavenger, oxygen scavenger, antislip agent, antistatic agent. As colourants, the various colourants known for colouring polymers, more in particular for colouring polyester, can be used. The present invention has been found to be especially suitable for colouring preforms for polyester bottles.

The esters are preferably tri-esters. The fatty acid component may be linear or branched and is selected from the C6 to C16, oleate or isostearate fatty acid moieties. More in particular it is preferred to use C6 to C14 fatty esters. More preferred are heptanoate, caprate, caprylate; laurate, isostearate and/or oleate. Most preferred are the trimethylolpropane tri-esters, of laurate, caprate and caprylate, optionally in combination of two or more thereof. The preferred esters, C6 to C14 have the important advantage of having strongly improved optical properties, i.e. they have superior haze properties in that the polymer or polymer blends containing them have a strongly reduced haze compared with other carriers.

In this respect it is to be noted that the fatty acids are natural products, which has the consequence, as is well known, that they consist of a mixture of various chain lengths, with the emphasis on the indicated value, i.e. a C8 fatty acid will accordingly also contain, apart from the majority of C8, also amounts of C6 and C10, or even some C4 or C12. It is thus to be understood that the chain length indicated for the fatty acid moiety is to be understood in the accepted sense in the art, namely that of a mixture of chain lengths distributed around the indicated value, with the chain length indicated being present as the largest fraction.

The composition of the concentrate, i.e. the amount of trimethylolpropane ester and additive, may vary strongly, dependent on the actual use, and materials. The amount of liquid carrier material in the said concentrate is preferably between 1 and 95 wt. %, more preferably between 5 and 75 wt. % the balance being the additive or additives.

The concentrate is introduced into the polymer or polymer blend at some stage during the production or processing thereof. It is preferred to introduce the concentrate during the melt processing/blending of the polymeric material, for example in the blender or extruder. However, adding the concentrate during the production of the polymer or directly after that, is also possible.

The level of concentrate to be used in the polymeric material is dependent on the various compositions, the additive concentration in the concentrate, the amount of additive/colourant, required in the polymer and the like.

The temperature at which the concentrate can be processed is relatively flexible. As indicated above, the material is very stable at all varying temperatures. This means that there is generally no need to deviate from the normal processing temperature of the polymer that is used.

The concentrate can be used to add additives to polymers for all kinds of applications, such as in injection moulding of PET preforms, but not limited to this. Also colouring of polyester sheet, fibres, and the like are possible. More in general, the concentrate may be used in combination with polyesters such as PET, PEN, PBT, polycarbonate, polylactide, ethylene polymers, propylene polymers and styrene polymers.

The concentrate can simply be prepared by mixing (milling) of the components in suitable equipment, such as a mixing tank equipped with a suitable dissolver blade and/or bead mill.

It is to be noted, that trimethylolpropane esters are known products that have a wide spectrum of applications in the chemical industry. Examples are lubricants, stabilizers, mould release agent and dispersion agents.

The invention is now elucidated on the basis of some, non-limiting examples.

### EXAMPLE 1

### Preparation of Colour Concentrate

Samples of a concentrate were produced using a Disperlux basket mill. 300 gram trimethylolpropane trilaurate was added to a 1-liter bucket, and then coloured powder (450 gram in a ratio 13:30:50 of Solvent Blue 67: Solvent Yellow 114: Solvent Red 195) was mixed in gradually. This mixture was dispersed with a stirring speed of 2000 rpm for 30 minutes. Dispersion fineness was checked on a Hegmann gauge. The final measured fineness was below 20 micron.

### EXAMPLE 2

### Preform and Bottle Production

The colour concentrate of EXAMPLE 1 was used to produce polyester (PET) preforms (Invista T94N resin (IV=0.84 dl/g)), 25 gr preform for 0.5 litre bottle with PCO neck finish) on an Arburg Allrounder 320 (extruder temperature profile, hot runner temperatures were set at 285° C.), equipped with a Piovan T200 dryer and DB-60 control unit (PET was dried to a dew point of −45° C.). Dosing of the colour concentrate at 0.6% was done using a Maguire liquid colour pump MPA 6-51. Preforms were blown on a Corpoplast LB01 using standard PET bottle blowing settings. The same preforms were produced without addition of the colour concentrate.

The Intrinsic Viscosity (IV) of the preforms was measured in solvent m-cresol, according to EC 00.02.03. PET parts were dissolved in m-cresol at 135° C. for 15 minutes. The measurement was performed at 25° C. The ASTM standard test method for measuring the haze and luminous transmittance of transparent plastics (D1003-61) was followed. All scans were performed using an integrating sphere (Diffuse Reflectance Accessory).

The results were as follows:

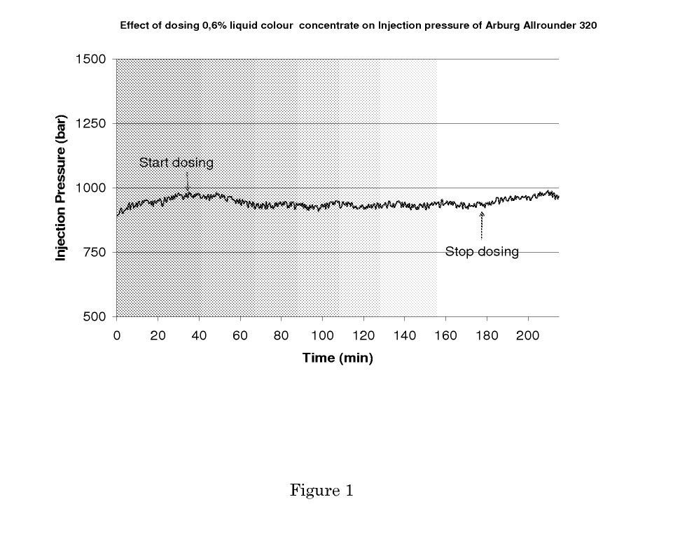

FIG. 1 shows a small effect of dosing on the injection pressure.
Colourless PET preform: IV=0.80 dl/g;
Coloured preform IV=0.79 dl/g
Results standard colourless PET

### Illuminant=CIE A

### Total Luminous Transmittance: Tt=0.8838

### Diffuse Luminous Transmittance: Td=0.0018

### Haze=0.2014%

### Results Coloured Preform:

### Illuminant=CIE A

### Total Luminous Transmittance: Tt=0.8829

### Diffuse Luminous Transmittance: Td=0.0019

### Haze=0.2155%

The above-mentioned results show that the intrinsic viscosity as well as the haze level are not affected by the dosing of the colourconcentrate.

### EXAMPLE 3

150 gram trimethylolpropane trilaurate was added to a 0.5-liter bucket, and then the iron powder (Hydrogen-reduced sponge iron particles obtained from Hoganas, Sweden) was mixed in gradually to a total of 25%. This mixture was dispersed with a stirring speed of 1000 rpm for 30 minutes in an inert nitrogen atmosphere. Dispersion fineness was checked on a Hegmann gauge. The final measured fineness was below 50 micron.

### EXAMPLE 4

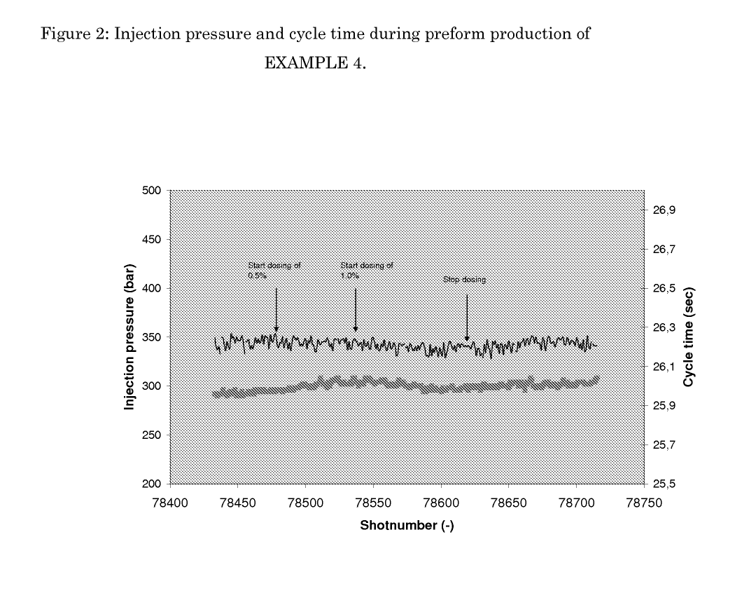

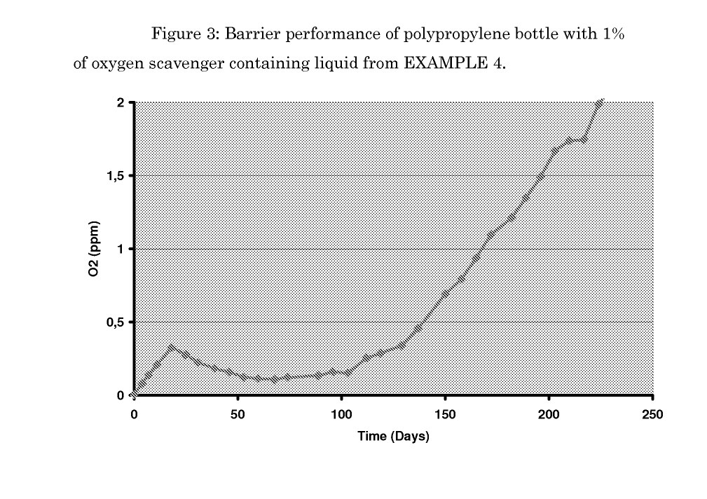

The additive concentrate from EXAMPLE 3 was dosed at 0.5% and 1% to polypropylene resin (Lyondell Basell Stretchene 1903 resin) on an Arburg Allrounder 320. In comparison with EXAMPLE 2, the extruder temperature profile was set to 245-245-250-250-250° C. The Hotrunner system was held at a temperature of 250° C. FIG. 2 shows that the overall cycle time was not affected and that the injection pressure was not lowered, despite the high amount of carrier. The preforms were blown on a Corpoplast LB01. Oxygen concentrations were determined with Oxysense equipment using fluorescence. FIG. 3 shows the oxygen scavenging performance of the bottle containing 1% of the oxygen scavenger containing liquid, indicating that the additive was successfully incorporated in the polymer matrix using the trimethylolpropane trilaurate carrier.

1. A concentrate comprising a liquid carrier material and at least one additive for a polymer or polymer blend, wherein the liquid carrier material is a fatty acid ester of trimethylolpropane, wherein the fatty acid is a C6 to C16 fatty acid having a linear or branched chain, oleic acid or isostearic acid.

2. The concentrate of claim 1, wherein the amount of liquid carrier material in the said concentrate is between 1 and 95 wt. % thereof.

3. The concentrate of claim 1, wherein the said ester of trimethylolpropane is a tri-ester.

4. The concentrate of claim 1, wherein the fatty acid is a C6 to C14 fatty acid.

5. The concentrate of claim 1, wherein the said ester is a heptanoate, caprate, caprylate; laurate, isostearate and/or oleate.

6. The concentrate of claim 1, wherein the said ester is a laurate, caprate and/or caprylate.

7. The concentrate of claim 1, wherein the additive is a colourant, a strengthening agent, a UV absorber, AA scavenger, oxygen scavenger, antislip agent, or antistatic agent.

8. The concentrate of claim 1, wherein the additive is a pigment or dye.

9. A method to introduce an additive to a polymer or polymer blend which method comprises contacting said polymer or polymer blend with the concentrate of claim 1.

10. The method of claim 9 wherein the additive is a pigment or dye.

11. The method of claim 9, wherein the polymer or polymer blend is selected from the group of polyesters, propylene polymers, ethylene polymers, styrene polymers, polycarbonate and blends thereof.

12. The method of claim 11, wherein the polyesters are polyethylene therephtalates or poly lactides.

13. The method of claim 12, wherein the polyesters are polyethylene therephtalates.

14. A process for producing a polyester material comprising adding a concentrate according to claim 1 to a melt of a polyester, melt blending the concentrate and the polyester and shaping the blend thus obtained to a preform, bottle, fibre, film or sheet.

15. The concentrate of claim 1 wherein the amount of liquid carrier material in the said concentrate is between 5 and 75 wt. %.
